(19) United States
(12) Patent Application Publication
(10) Pub. No.: US 2008/0244212 A1
(43) Pub. Date: Oct. 2, 2008

(54) SYSTEM AND METHOD TO ENABLE HIERARCHICAL DATA SPILLING

(76) Inventors: Michael A. Rothman, Puyallup, WA (US); Vincent J. Zimmer, Federal Way, WA (US)

Correspondence Address: INTEL/BSTZ;BLAKELY SOKOLOFF TAYLOR & ZAFMAN LLP, 1279 OAKMEAD PARKWAY, SUNNYVALE, CA, 94085-4040, US

(21) Appl. No.: 11/693,529

(22) Filed: Mar. 29, 2007

(51) Int. Cl. G06F 12/00

(52) U.S. Cl. 711/172; 711/103; 711/E12.001

(57) ABSTRACT

In some embodiments, the invention involves managing access to firmware non-volatile storage which is currently an extremely limited resource. A system and method provide a seamless means by which to enable spilling of such access to an alternate non-volatile storage target. One embodiment uses a virtualization platform to proxy NV store I/O requests via a virtual machine manager (VMM). Another embodiment uses an embedded platform to proxy I/O requests. Another embodiment uses IDS redirection in an embedded microcontroller on the platform to proxy I/O requests. Non-priority data may be stored in the alternative medium, even when space is available on the firmware memory store, based on platform policy. Other embodiments are described and claimed.

### FIELD OF THE INVENTION

An embodiment of the present invention relates generally to computing platforms and, more specifically, to provide access to non-volatile storage which is currently an extremely limited resource and provide a seamless means by which to enable spilling of such access to alternate non-volatile storage targets.

### BACKGROUND INFORMATION

Various mechanisms exist for saving configuration data and other platform related information. In existing systems, vendors and manufacturers have begun to use the firmware memory storage, typically Flash memory, to store configuration data. This has been made easier to implement due to the advent of extensible firmware interface (EFI) architectures. Operating system (OS) vendors have developed and provided abstractions to access some of the EFI Get and Set variable application programming interfaces (APIs). These APIs access and store information into the non-volatile (NV) store on a platform, e.g., Flash memory.

Firmware non-volatile memory, or Flash memory, is typically limited in size. Traditionally, the Flash has been used to store policy variables that are used in EFI. However, there is no standardized file system or structure to be used for firmware NV store. Therefore developers and vendors run the risk of filling up or overflowing the available memory. In existing systems, attempting to write more data than will fit into the NV store may result in failure to boot, system crash, etc.

### BRIEF DESCRIPTION OF THE DRAWINGS

The features and advantages of the present invention will become apparent from the following detailed description of the present invention in which:

FIG. 1 is a block diagram illustrating features of platform having an out-of-band microcontroller (OOB μcontroller), according to an embodiment of the environment;

FIG. 2 is an exemplary block diagram of a platform having platform resource layer (PRL), or embedded partition, architecture, according to embodiments of the invention;

FIG. 3 is a block diagram of an exemplary virtualization platform where the spill agent resides in a virtual machine manager (VMM), according to an embodiment of the invention;

FIG. 4 is a block diagram illustrating various partitions on a physical medium such as a hard disk, according to an embodiment of the invention; and

FIG. 5 is a flow diagram illustrating an exemplary method for spilling data to an alternate memory, according to an embodiment of the invention.

### DETAILED DESCRIPTION

An embodiment of the present invention is a system and method relating to storing overflow data meant for the firmware non-volatile memory store to be alternatively stored in a secondary non-volatile memory store. The alternative store may be used automatically, based on platform policy, or only when there is a risk that the firmware NV store is full, or nearly full.

Reference in the specification to “one embodiment” or “an embodiment” of the present invention means that a particular feature, structure or characteristic described in connection with the embodiment is included in at least one embodiment of the present invention. Thus, the appearances of the phrase “in one embodiment” appearing in various places throughout the specification are not necessarily all referring to the same embodiment.

For purposes of explanation, specific configurations and details are set forth in order to provide a thorough understanding of the present invention. However, it will be apparent to one of ordinary skill in the art that embodiments of the present invention may be practiced without the specific details presented herein. Furthermore, well-known features may be omitted or simplified in order not to obscure the present invention. Various examples may be given throughout this description. These are merely descriptions of specific embodiments of the invention. The scope of the invention is not limited to the examples given.

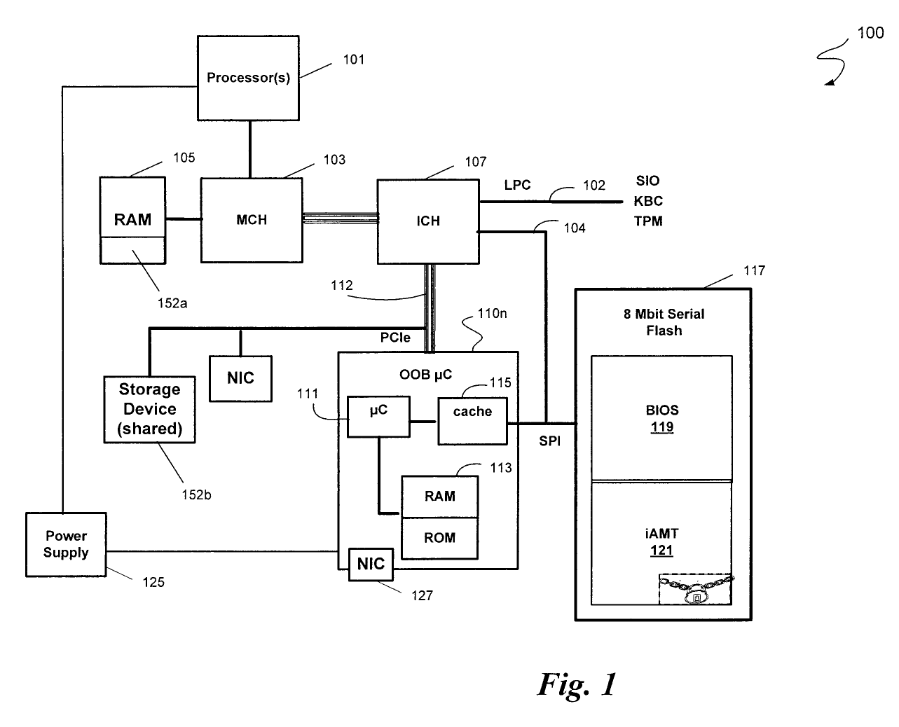

FIG. 1 is a block diagram illustrating features of platform having an out-of-band microcontroller (OOB μcontroller), according to an embodiment of the environment. A platform 100 comprises a processor 101. The processor 101 may be connected to random access memory 105 via a memory controller hub (MCH) 103. Processor 101 may be any type of processor capable of executing software, such as a microprocessor, digital signal processor, microcontroller, or the like. Though FIG. 1 shows only one such processor 101, there may be one or more processors in the platform 100 and one or more of the processors may include multiple threads, multiple cores, or the like.

The processor 101 may be further connected to I/O devices via an input/output controller hub (ICH) 107. The ICH may be coupled to various devices, such as a super I/O controller (SIO), keyboard controller (KBC), or trusted platform module (TPM) via a low pin count (LPC) bus 102. The SIO, for instance, may have access to floppy drives or industry standard architecture (ISA) devices. In an embodiment, the ICH is coupled to non-volatile memory 117 via a serial peripheral interface (SPI) bus 104. The non-volatile memory may be Flash memory or static random access memory (SRAM), or the like. For purposes of illustration, this non-volatile (NV) memory may be referred to as the NV store or Flash memory 117. An out-of-band (OOB) μcontroller 110 may be present on the platform 100. The OOB μcontroller 110 may connect to the ICH via a bus 112, typically a peripheral component interconnect (PCI) or PCI express bus. The OOB μcontroller may also be coupled with the non-volatile memory store (NV store) 117 via the SPI bus 104. The NV store 117 may be Flash memory or static RAM (SRAM), or the like. In many existing systems, the NV store is Flash memory.

The OOB μcontroller 110 may be likened to a “miniature” processor. Like a full capability processor, the OOB μcontroller has a processor unit 111 which may be operatively coupled to a cache memory 115, as well as RAM and ROM memory 113. The OOB μcontroller may have a built-in network interface 127 and independent connection to a power supply 125 to enable out-of-band communication even when the in-band processor 101 is not active.

In embodiments, the processor has a basic input output system (BIOS) 119 in the NV store 117. In other embodiments, the processor boots from a remote device (not shown) and the boot vector (pointer) resides in the BIOS portion 119 of the NV store 117. The OOB μcontroller may have access to all of the contents of the NV store 117, including the BIOS portion 119 and a protected portion 121 of the non-volatile memory. In some embodiments, the protected portion 121 of memory may be secured with Intel® Active Management Technology (iAMT). More information about iAMT may be found on the public Internet at URL www*intel*com/technology/manage/iamt/. In an embodiment, the portion 121 of the NV store is protected from access by the firmware based on chipset selections in a base address register (BAR). It should be noted that periods have been replaced with asterisks in URLs contained within this document in order to avoid inadvertent hyperlinks.

Since the BIOS portion of non-volatile memory may be modified by the OS or applications running within the OS, it is vulnerable to malicious tampering. The protected area of memory 121, available only to the OOB μcontroller, may be used to store critical boot vector information without risk of tampering. In an embodiment, the only way to access the OOB μcontroller side of the NV store 117 is through verification via a proxy through the OOB μcontroller, i.e., signature authentication or the like.

Embodiments of the present invention utilize a hardware protected region 121 of the non-volatile memory 117 and make the protected region inaccessible to the OS. The OOB μcontroller 110 controls this protected portion of the non-volatile memory 117. Thus, the firmware (BIOS) cannot access the protected portion 121. Further, applications running under the OS cannot directly communicate with the OOB μcontroller. Therefore, these applications have no access to the protected portion 121. This area of memory may be protected by base address registers in the chipset, or by any other means available.

In an embodiment, implementation of “mailboxes” to pass messages and data between the in-band (or host processor) and an out-of-band processor is according to techniques discussed in U.S. patent application Ser. No. 10/964,355 (Attorney Docket: P19896), entitled “BUS COMMUNICATION EMULATION” to Rothman et al. and filed on Oct. 12, 2004.

The OOB μcontroller 110 may be operated to store a “message” containing a directive in a memory shared by the OOB μcontroller 110 and a processor of the computer system such as the processor 101 of the platform 100. In the illustrated embodiment, the host processor 101 includes a shared memory 152 which is accessible by both the processor and the OOB μcontroller 110. The shared memory 152 may reside in a reserved area of RAM 152a, or be located in a separate non-volatile memory store 152b, or the like. The shared memory may be operated as a mailbox for these messages. Thus, in one aspect, the OOB μcontroller 110 may store a message in the shared memory 152 or retrieve a message from the shared memory 152, independently of the status of the host processor 101.

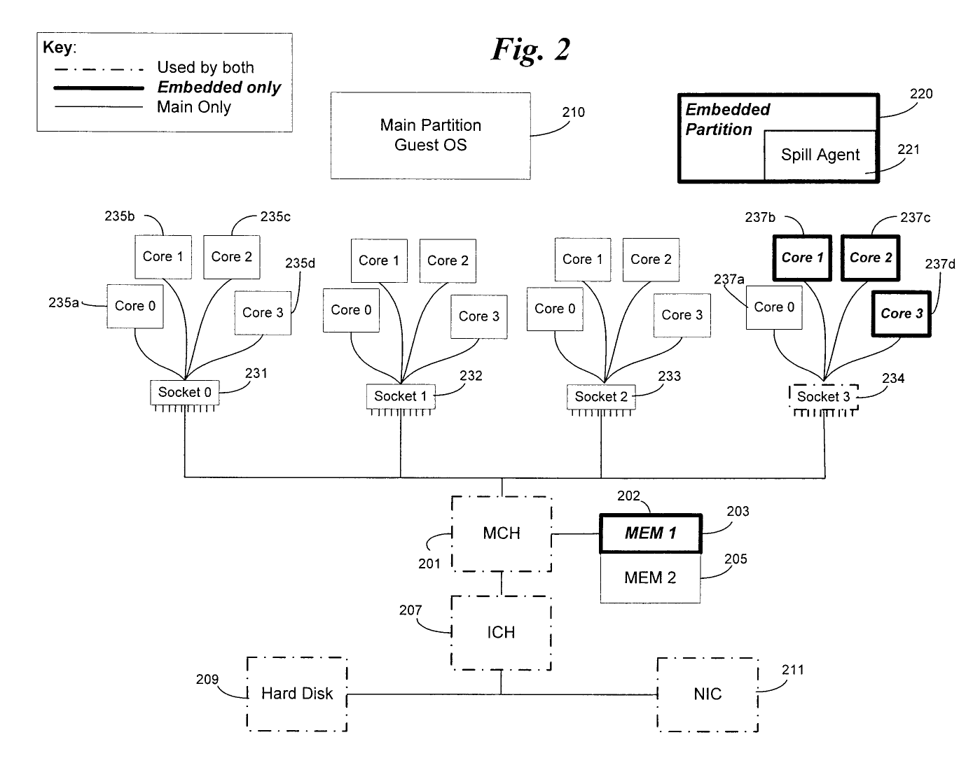

In a platform resource layer (PRL) architecture, or embedded partition architecture, various components of the platform are enhanced to enable partitioning of processor, memory and other resources. Referring now to FIG. 2, there is shown an exemplary block diagram of a platform with a PRL architecture, according to embodiments of the invention. To better illustrate partitioning, components that are available to the main partition 210 are drawn with solid blocks. Components available to the embedded, or system partition 220, are drawn with bold, solid blocks. Components available to both partitions are drawn with a block alternating with dots and dashes.

In this exemplary embodiment, a platform has four multi-core processors in Sockets 0-3 (231-234). While this example shows only four processor sockets, it will be apparent to one of ordinary skill in the art that various configurations of processors and cores may be used to practice embodiments of the invention. For instance, Socket 0 (231) may have four processing cores 235a-d. In essence, in this example, the illustrated embodiment has 16 effective processors on the platform (e.g., four sockets with four cores in each socket). In this example, Sockets 0-2 (231-233) are available only to the main partition 210. Socket 3 (234) is available to both the main partition 210 and to the embedded partition 220. Within Socket 3 (234), core 0 (237a) is available only to the main partition 210, and cores 1-3 (237b-d) are available only to the embedded partition 220. The embedded partition 220 has the spill agent 221, as more fully discussed below.

In this embodiment, the platform has a memory controller hub (MCH) 201 (also known as north bridge) coupled to memory 202. Memory 202 may have two partitions MEM1 (203) and MEM2 (205). Memory partition MEM1 (203) is available only to the embedded partition and memory partition MEM2 (205) is available only to the main partition. The chipset containing the MCH is configured to partition the memory using hardware constructs, in contrast to a virtual machine manager (VMM) solution which uses software constructs. It will be understood that memory 202 may be a hard disk, a floppy disk, random access memory (RAM), read only memory (ROM), Flash memory, or any other type of medium readable by processor. Memory 202 may store instructions for performing the execution of embodiments of the present invention. While only two partitions are shown in this example, it will be understood that there may be more than one guest OS, each running in its own partition.

The MCH 201 may communicate with an I/O controller hub (ICH) 207, also known as South bridge, via a peripheral component interconnect (PCI) bus. The ICH 207 may be coupled to one or more components such as PCI hard drives, legacy components such as IDE, USB, LAN and Audio, and a Super I/O (SIO) controller via a low pin count (LPC) bus (not shown). In this example, the ICH 207 is shown coupled to a hard disk drive 209 and to a network interface controller (NIC) 211.

The MCH 201 is configured to control accesses to memory and the ICH 207 is configured to control I/O accesses. In an embedded partition architecture, the chipset is configured by the firmware, upon boot, to partition the various resources on the platform. In some cases, there may be only one partition and the platform acts like a legacy platform in most respects. In the example shown, there are two partitions, a main partition 210 and an embedded partition 220. Each partition designated is given a unique partition identifier (ID).

With an embedded partition configuration, when a device sends an alert, the chipset may properly route the alert to the appropriate partition, as this information is encoded at boot time. In a virtual machine management (VMM) enabled system, the hardware passes the device alerts to the VMM (virtualized devices) and the software routes the information appropriately to the various virtual machines. An embedded partition may act as hardware assisted virtualization.

In an embodiment, a spill agent is embodied within a VMM which controls all guest virtual machines (VMs) and guest operating systems (OS's) running on the platform. In another embodiment, the spill agent is embodied in a privileged partition, process or hypervisor that controls I/O requests for individual OS's. In all cases, the spill agent selectively stores data intended for the NV store into either the NV store or an alternative medium. In the case of a VMM architecture, device access is virtualized and the spill agent acts as a software intermediary to store/retrieve data to/from the device.

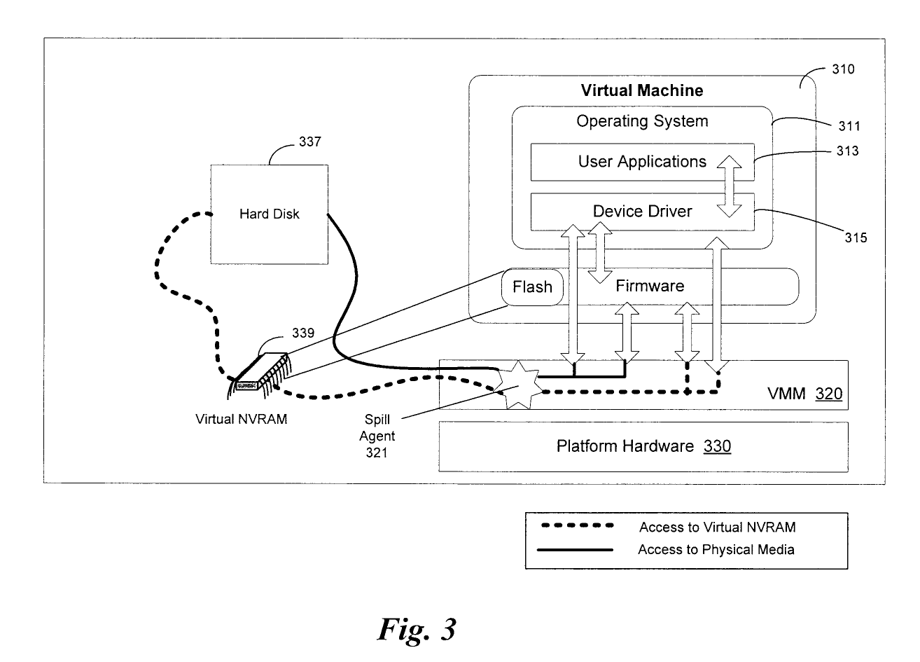

Referring now to FIG. 3, an exemplary virtualization platform where the spill agent 321 resides in a VMM 320 is shown. In this exemplary embodiment, a virtual machine (VM) 310 has a guest OS 311. Various user applications 313 may run under the guest OS 311. The OS has device drivers 315 which may be virtualized within the VMM 320. Access to platform hardware 330, and firmware memory 339 will require the use of the VMM. In the case of storing data on the firmware memory 339, a spill agent 321 within the VMM 320 may intercept device access to the firmware memory 339, typically Flash memory, and a hard drive 337, or other non-volatile memory, and control whether data is read/written to/from the firmware memory 339 or hard drive 337. A virtual NVRAM abstraction may be used by the spill agent 321 to manage access to the firmware memory 339 and control when data is to spill into the hard disk 337.

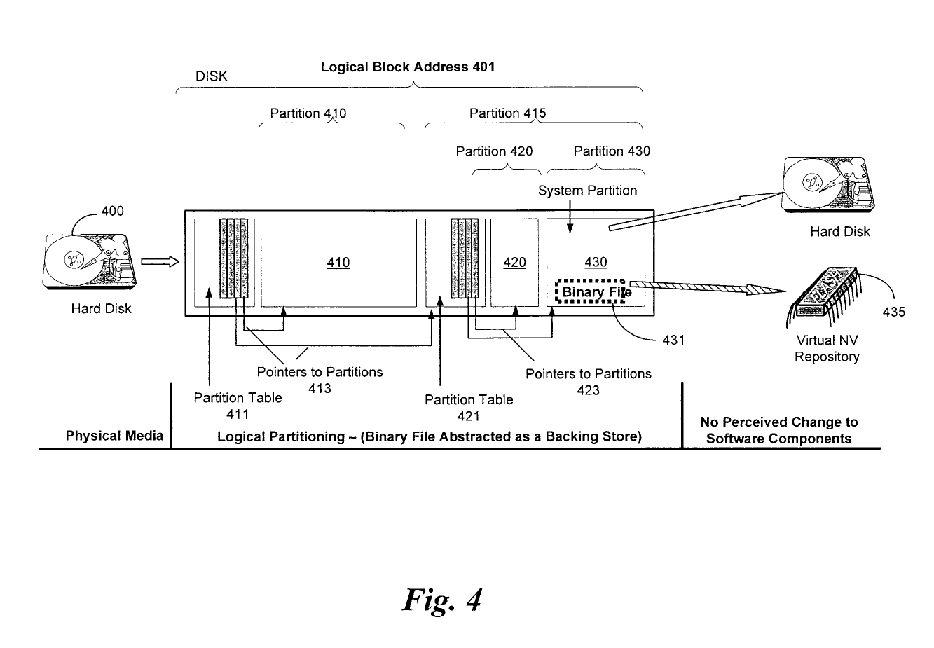

FIG. 4 illustrates various partitions on a physical medium such as a hard disk, according to an embodiment of the invention. A hard drive 400 is partitioned into a number of logical partitions 401. Hard drive 400 has several levels of logical partitioning. For instance, as illustration, three partitions are shown 410, 420 and 430. The third partition 430 is the system partition. A partition table 411 may exist for a partition 410 and have pointers 413 into the partition 410. A second partition table 421 may have pointers 423 to both partition 420 and the system partition 430. Logical partition 415 has both the partition 420 and the system partition 430. The system partition may have a binary file 431. Platform utilities and system services are typically stored in the system partition 430. The system partition is not exposed to users or user applications, but typically, only to the firmware.

In an embodiment of the invention, data overflowed, or spilled over, from the firmware memory may be stored in a system partition. This shields the data from user access and tampering, because the user applications cannot access the system partition. Other embodiments may use techniques that avoid utilizing a system partition, for instance, by spilling data to a network device. It will be understood that at least one of various types of alternative non-volatile storage, in addition to the firmware memory (Flash), is required to implement embodiments of the invention.

The spill agent (221/321) captures device accesses to the firmware memory, either by chipset partitioning or VMM device virtualization, as described above. The spill agent controls the flow of information to non-volatile storage. The agent may determine which variables and data are high priority, and store them in the firmware memory and store lower priority data in alternative non-volatile storage, for instance the system partition 430 of a hard drive 400.

The system partition 430 may be 100 MB in size. A binary file 431 is identified within the partition to hold overflow, or spill over data from the firmware memory. This file may be defined to be 10 MB, or some specific size for a repository. The binary file repository is abstracted in a virtual NV repository 435. The virtual repository keeps track of where the data has been stored, e.g., in the firmware memory or in the alternate NV location.

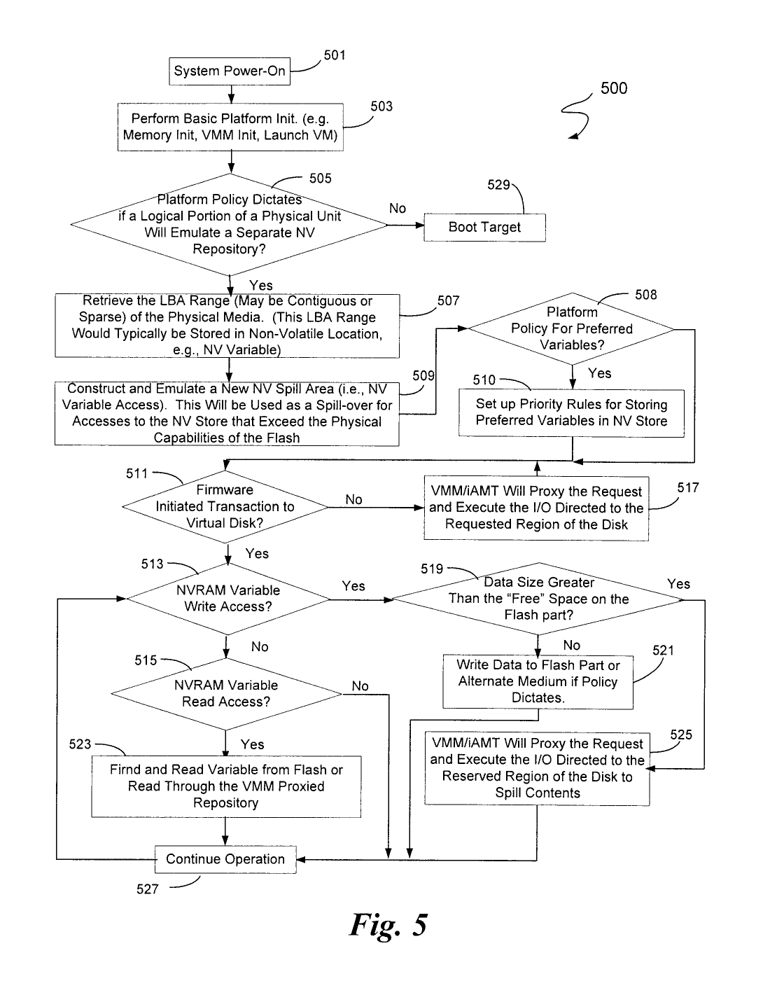

FIG. 5 is a flow diagram illustrating an exemplary method 500 for spilling data to an alternate NV store, according to an embodiment of the invention. After system power on (501) a basic platform initialization is performed in block 503. For instance, memory is initialized, and for virtualization architecture platforms, the virtual machine manager (VMM) is initialized and a virtual machine (VM) is launched. Platform policy may dictate if a logical portion of a physical medium is to be used as alternate storage for firmware memory overspill. A determination is made as to whether this policy exists for the platform in block 505. If none exists, then the platform boots as normal in block 529.

If the platform policy dictates an overspill policy, then, in one embodiment, the logical block address (LBA) range of the physical medium is retrieved in block 507. An LBA is equivalent to a sector on a hard drive. The LBA range is typically stored in a non-volatile location, for instance in an NV variable. The range may be contiguous on the medium, or sparse. By taking a logical aggregation of sectors from a physical device, one can emulate a new physical device. These aggregations may be logical files, sector ranges, or sparse set of data sectors. This opens a common target for data available in both the pre-boot and runtime and allows for a common repository for non-volatile transitional data. In a VMM environment, by virtualizing the disk controller, a logical subset of the disk media may be represented as a separate virtual unit. This virtual unit may be mounted and used equally well in the pre-boot and runtime. This enables the seamless emulation of a file as a drive. A spill area is constructed for emulation on the medium, in block 509, based on the platform architecture (embedded partition or VMM). The spill area may be used for accesses to the firmware memory, or NV store, that exceed the physical characteristics of the NV store, for instance, if the firmware NV store is 64K and 63K is full. If a request is made to store 5K, an existing system would crash or at least result in an error. In embodiments of the present invention, the 5K data storage request will be fulfilled, but the data will be physically stored in the alternate medium.

In another embodiment, if the variable being stored or manipulated is classified as “preferred,” the data will preferentially be stored in the firmware NV store. If the data to be stored is not “preferred” or not a priority, it may be stored in the alternate medium regardless of free space available. In this way, there will likely be room in the NV store for preferred data, when needed. It will be understood that a variety of platform policies may be generated to effect a desired result in terms of storing priority data in the NV store.

In one embodiment, after the spill area is constructed, a determination is made as to whether a preferential policy exists on the platform, in block 508. If a policy exists, then priority rules for storing preferred variables in the NV store first are initiated, in block 510. Various policies may affect the order of processing, as illustrated in the discussion of the flow chart in FIG. 5

A determination is made as to whether the firmware has initiated a transaction to virtual disk, in block 511. If not, then a proxied request and execution of the I/O is directed to the requested portion of the disk, in block 517. If so, then a determination is made as to whether a write access is requested, in block 513. If a write is requested, a determination is made as to whether the data to write is larger than the “free” space on the firmware memory, in block 519. If so, then the data must be written to the alternate memory store. Thus, the VMM/iAMT/partition will proxy the write request and execute the I/O to the reserved region of the alternate memory store to spill the contents, in block 525.

If the data is not larger than the free space, then the data may be written to the firmware memory store, in block 521. However, if the data is non-preferential, and a preferential policy exists for the platform, the data may be written to the alternate memory store as in block 525. Once the data has been written, operations continue at block 527.

If the access is a read access, as determined in block 515, then the spill agent determines where the variable is actually located, e.g., alternate NV store or firmware memory store. The data is then read from firmware memory or read through a VMM/iAMT/partition proxied repository, in block 523. Once read, operation continues at 527. If the requested access is neither write nor read, then boot operations continue at 527 until another write or read access occurs at 513 or 515.

In another embodiment, the iAMT, or OOB μcontroller, may proxy disk access for the platform. The iAMT μcontroller may perform IDE redirection. IDE redirection on the firmware storage medium may be leveraged to selectively store data to a shared storage medium, for instance, as shown in FIG. 1, 152b. In another embodiment, the OOB μcontroller may use its out-of-band capabilities to provide alternate storage on a remote device, without the need to communicate via a platform, or host network controller. In existing systems, the iAMT may not have the capacity to handle all of the transactions to firmware memory. However, this technique may be used in future systems.

The techniques described herein are not limited to any particular hardware or software configuration; they may find applicability in any computing, consumer electronics, or processing environment. The techniques may be implemented in hardware, software, or a combination of the two.

For simulations, program code may represent hardware using a hardware description language or another functional description language which essentially provides a model of how designed hardware is expected to perform. Program code may be assembly or machine language, or data that may be compiled and/or interpreted. Furthermore, it is common in the art to speak of software, in one form or another as taking an action or causing a result. Such expressions are merely a shorthand way of stating execution of program code by a processing system which causes a processor to perform an action or produce a result.

Each program may be implemented in a high level procedural or object-oriented programming language to communicate with a processing system. However, programs may be implemented in assembly or machine language, if desired. In any case, the language may be compiled or interpreted.

Program instructions may be used to cause a general-purpose or special-purpose processing system that is programmed with the instructions to perform the operations described herein. Alternatively, the operations may be performed by specific hardware components that contain hardwired logic for performing the operations, or by any combination of programmed computer components and custom hardware components. The methods described herein may be provided as a computer program product that may include a machine accessible medium having stored thereon instructions that may be used to program a processing system or other electronic device to perform the methods.

Program code, or instructions, may be stored in, for example, volatile and/or non-volatile memory, such as storage devices and/or an associated machine readable or machine accessible medium including solid-state memory, hard-drives, floppy-disks, optical storage, tapes, Flash memory, memory sticks, digital video disks, digital versatile discs (DVDs), etc., as well as more exotic mediums such as machine-accessible biological state preserving storage. A machine readable medium may include any mechanism for storing, transmitting, or receiving information in a form readable by a machine, and the medium may include a tangible medium through which electrical, optical, acoustical or other form of propagated signals or carrier wave encoding the program code may pass, such as antennas, optical fibers, communications interfaces, etc. Program code may be transmitted in the form of packets, serial data, parallel data, propagated signals, etc., and may be used in a compressed or encrypted format.

Program code may be implemented in programs executing on programmable machines such as mobile or stationary computers, personal digital assistants, set top boxes, cellular telephones and pagers, consumer electronics devices (including DVD players, personal video recorders, personal video players, satellite receivers, stereo receivers, cable TV receivers), and other electronic devices, each including a processor, volatile and/or non-volatile memory readable by the processor, at least one input device and/or one or more output devices. Program code may be applied to the data entered using the input device to perform the described embodiments and to generate output information. The output information may be applied to one or more output devices. One of ordinary skill in the art may appreciate that embodiments of the disclosed subject matter can be practiced with various computer system configurations, including multiprocessor or multiple-core processor systems, minicomputers, mainframe computers, as well as pervasive or miniature computers or processors that may be embedded into virtually any device. Embodiments of the disclosed subject matter can also be practiced in distributed computing environments where tasks or portions thereof may be performed by remote processing devices that are linked through a communications network.

Although operations may be described as a sequential process, some of the operations may in fact be performed in parallel, concurrently, and/or in a distributed environment, and with program code stored locally and/or remotely for access by single or multi-processor machines. In addition, in some embodiments the order of operations may be rearranged without departing from the spirit of the disclosed subject matter. Program code may be used by or in conjunction with embedded controllers.

While this invention has been described with reference to illustrative embodiments, this description is not intended to be construed in a limiting sense. Various modifications of the illustrative embodiments, as well as other embodiments of the invention, which are apparent to persons skilled in the art to which the invention pertains are deemed to lie within the spirit and scope of the invention.

What is claimed is:

1. A system comprising:
a platform having firmware coupled to a non-volatile memory store;
an alternate non-volatile memory store communicatively coupled to the platform;
a spill agent to control read/write access to the non-volatile memory store; wherein the spill agent selectively stores data intended for the non-volatile memory store in the alternate memory store.

2. The system as recited in claim 1, wherein the spill agent selectively stores data in the alternative memory store based on a platform policy.

3. The system as recited in claim 2, wherein the platform policy has rules dictating where to store preferential and non-preferential data, and wherein the platform policy utilizes a determination of free space on the non-volatile store to dictate where to store the data.

4. The system as recited in claim 1, wherein the spill agent resides in one of an embedded platform, a virtual machine manager (VMM) or an embedded microcontroller on the platform, and wherein the spill agent is to proxy I/O requests to the non-volatile memory store.

5. The system as recited in claim 4, wherein the embedded microcontroller has out-of-band communication capabilities and the alternative memory store resides on a remote device.

6. The system as recited in claim 1, wherein the alternate memory store resides as a binary file in a system partition on a hard disk coupled to the platform.

7. A method comprising:
managing read/write access to a firmware memory store by a spill agent on a platform;
selectively storing data intended for the firmware memory in an alternate memory store, by the spill agent, the storage location being based on at least one of space available in firmware memory and data priority.

8. The method as recited in claim 7, wherein managing storing data further comprises:
determining whether the data is larger than free space available in the firmware memory store, and if so storing the data in the alternate memory store.

9. The method as recited in claim 8, further comprising:
determining whether the data is not larger than the free space available on the firmware memory store, and if so, storing the data in the firmware memory store when platform policy dictates that the data is a high priority item, and storing the data in the alternate memory store when platform policy dictates that the data is not a high priority item.

10. The method as recited in claim 7, wherein the spill agent resides in one of an embedded platform, a virtual machine manager (VMM) or an embedded microcontroller on the platform, further comprising, proxying I/O requests to the non-volatile memory store by the spill agent.

11. The method as recited in claim 10, wherein the embedded microcontroller has out-of-band communication capabilities, and wherein the alternative memory store resides on a remote device, further comprising communicating with the remote device via the out-of-band capabilities of the embedded microcontroller to access the alternative memory store.

12. A machine accessible storage medium having instructions stored therein, that when executed on a machine cause the machine to:
manage read/write access to a firmware memory store by a spill agent on a platform;
selectively store data intended for the firmware memory in an alternate memory store, by the spill agent, the storage location being based on at least one of space available in firmware memory and data priority.

13. The medium as recited in claim 12, wherein managing storing data further comprises instructions to:
determine whether the data is larger than free space available in the firmware memory store, and if so store the data in the alternate memory store.

14. The medium as recited in claim 13, further comprising instructions to:
determine whether the data is not larger than the free space available on the firmware memory store, and if so, store the data in the firmware memory store when platform policy dictates that the data is a high priority item, and store the data in the alternate memory store when platform policy dictates that the data is not a high priority item.

15. The medium as recited in claim 12, wherein the spill agent resides in one of an embedded platform, a virtual machine manager (VMM) or an embedded microcontroller on the platform, further comprising instructions to: proxy I/O requests to the non-volatile memory store by the spill agent.

16. The medium as recited in claim 15, wherein the embedded microcontroller has out-of-band communication capabilities, and wherein the alternative memory store resides on a remote device, further comprising instructions to communicate with the remote device via the out-of-band capabilities of the embedded microcontroller to access the alternative memory store.
